(19) United States
(12) Patent Application Publication
(10) Pub. No.: US 2015/0164270 A1
(43) Pub. Date: Jun. 18, 2015

(54) Sanitary Bag System for Warming Nutritional Liquid for Neonates

(71) Applicant: Angele Innovations, LLC, San Marcos, CA (US)

(72) Inventor: Janice M. Shields, San Marcos, CA (US)

(73) Assignee: Angele Innovations, LLC, San Marcos, CA (US)

(21) Appl. No.: 14/106,387

(22) Filed: Dec. 13, 2013

(51) Int. Cl. A47J 36/24

(52) U.S. Cl. CPC A47J 36/2405; A47J 36/2483

(57) ABSTRACT

A disposable system for use in warming a neonate nutritional liquid is disclosed and includes a pouch having a first flexible bag attached to a rigid connecting component and a second flexible bag. To establish the pouch, the two flexible bags are arranged as an inner and outer bag and are coupled to each other to establish a permanently sealed compartment between the bags which houses a thermally conductive fluid. A liner having a flexible bag attached to a rigid connector component is placed within and removably attached to the pouch. A container of neonate nutritional liquid is placed in the disposable system and the assembly is placed in a warming well. A heating coil is then activated to heat the warming well. Heat from the warming well passes through the conductive fluid to safely and uniformly heat the neonate nutritional liquid.

### FIELD OF THE INVENTION

The present invention pertains generally to a sanitary bag system for heating liquids in a hospital setting. More particularly, the present invention pertains to sanitary bag systems for heating neonate nutritional liquids such as mother's milk or prepared formula. The present invention is particularly, but not exclusively, useful as a disposable sanitary bag system for use with a warmer having a heated, warming well for the purpose of warming a nutritional liquid prior to administering the liquid to a neonate.

### BACKGROUND OF THE INVENTION

Nutritional fluids for neonates (i.e. infants less than about 4 weeks old) must be served at the proper temperature and must be free of harmful bacteria. As is well known, such fluids include prepared formula as well as preserved mother's milk. In any event, the optimal serving temperature is about 97° F.; close to the temperature that breast milk is delivered directly by a mother. Since this temperature is 27° Fahrenheit above room temperature, the nutritional fluids must typically be warmed before they are administered to the neonate. During warming of the fluid, care must be taken to avoid overheating the fluid. In fact, temperatures over about 100° F. can kill enzymes, proteins, blood cells and many other components of breast milk. These temperatures can also cause destruction of other nutritional fluids. In this regard, heating techniques that rely on radiation and/or convective heat transfer tend to heat the fluid in a non-uniform and possibly dangerous manner. This can cause harm to the neonate due to burns or other tissue destruction due to the mistreatment of the nutritional fluid. This non-uniform heating can often result in hot spots (i.e. portions of the fluid that are overheated), resulting in the destruction of important fluid components.

One technique for uniformly heating a container of nutritional liquid involves placing the container in the warming well of a warmer. For this process, the use of a conductive fluid, such as water in the well, can be used to improve heat transfer and promote uniform heating. In addition, vibration of the well can be used to improve heat transfer and promote uniform heating. However, when containers are loosely placed within the well, vibration can cause the container of nutritional liquid to move within the well. In some cases, this undesirable movement is sufficient to cause the container of nutritional liquid to move to a position within the well where uniform heating no longer occurs.

While handling the nutritional fluid, and during the warming process, it is important to ensure that bacteria is not introduced into the nutritional fluid. This is because exposure of a neonate to certain types of bacteria can cause adverse complications. One such adverse complication, necrotizing enterocolitis (NEC) occurs in about 3%-7% of all infants in neonatal intensive care units. This percentage of NEC increases as the birth weight of the neonate decreases. In more detail, NEC is an inflammatory gastrointestinal (GI) disease which causes tissue necrosis in the GI tract. Unfortunately, a large percentage of neonates that contract NEC die of the disease (in one study an NEC morbidity rate exceeding 25 percent was found).

As described above, oftentimes water is introduced into a warming well of a warmer to facilitate uniform heating of a container of nutritional fluid. In some cases, this water is obtained at a hospital faucet, sometimes sterilized in a hospital setting, and introduced into bags or containers by hospital personnel, such as nurses. Unfortunately, these procedures are time-consuming, often result in the introduction of contaminates into the warming process and waste valuable hospital resources. On the other hand, the present invention recognizes that it is more efficient to sterilize and permanently seal a warming fluid in a pouch at a remote, sterile processing facility, rather than attempt to produce a sterile water-filled pouch in an often contaminated hospital environment.

In light of the above, it is an object of the present invention to provide a disposable system, and corresponding method of use, for safely and uniformly warming a neonate nutritional fluid while minimizing the introduction of harmful bacteria into the warming process. Another object of the present invention is to provide a disposable bag system that holds a container of neonate nutritional fluid in place within a warming well of a warmer during vibration of the warming well to ensure that uniform heating occurs. Yet another object of the present invention is to provide a disposable, ready-to-use system for warming a neonate nutritional fluid in a warming well that uses conductive heat transfer to avoid overheating the fluid. Still another object of the present invention is to provide a sanitary bag system for warming a neonate nutritional liquid that is easy to use and comparatively cost effective.

### SUMMARY OF THE INVENTION

In accordance with the present invention, a disposable system for use in warming a neonate nutritional liquid includes a pouch and a liner. The pouch includes a first flexible bag, a second flexible bag and a rigid connecting component. To establish the pouch, the two flexible bags are arranged as an inner and outer bag and are coupled to each other to establish a permanently sealed compartment between the bags. For the present invention, at least one of the bags is attached to the connecting component. With this arrangement, the pouch extends from a closed first end at the connecting component to a second, open pouch end.

Also for the present invention, a thermally conductive fluid is disposed within the compartment that is established by the pouch. For example, the thermally conductive fluid may be a sanitized gel type substance or it may be a liquid, such as sanitized water. As detailed further below, this cooperation of structure allows heat to flow from the outside of the pouch to a neonate nutritional liquid that is disposed within the pouch.

In addition to the pouch, the disposable system includes a liner having a flexible bag and a rigid connector component. For the system, one end of the liner bag is attached to the connector component and the other end of the liner bag is open to receive a container of neonate nutritional liquid.

To assemble the pouch and liner together, the connector component of the liner is first inserted into the pouch. Then, the connector component of the liner is engaged with the connecting component of the pouch to removably attach the liner to the pouch. With this arrangement, a liner can be removed from a pouch and replaced with a new liner. For the disposable system, it is envisioned that the pouch will have a useful life of about one (1) week while the less expensive liners will be replaced after about twelve (12) hours of use or about four neonatal feedings. With this in mind, a typical kit for the disposable system can include a sealed package having a single pouch and a plurality, e.g. ten or more liners, all sterilized and ready for immediate use.

In one embodiment of the disposable system, the rigid connecting component of the pouch comprises an annular ring that surrounds a recess. For use with the ring, the rigid connector component of the liner can be formed as a disk or as a ring. To establish the attachment, either the pouch connecting component or the liner connector component is formed with a tang and the other is formed with a groove. The groove is sized to receive the tang and snap the connecting component and connector component together. For example, the disk and ring can be made of plastic. In another embodiment, a two piece snap fastener similar to the snap fasteners used in clothing can be used as the pouch connecting component and the liner connector component to removably attach the liner to the pouch.

For the disposable system, the flexible bag portion of the liner can include a mechanical seal that is located adjacent the open end of bag. With this structure, a seal can be established to selectively enclose the container of neonate nutritional liquid inside the liner during a warming procedure. In one embodiment, the mechanical seal is a ridge-into-groove connector, sometimes referred to as a so-called ‘zip-lock’ or ‘plastic zipper’ type seal. In another embodiment, the mechanical seal can include an adhesive that is positioned along at least 50% of a periphery of the liner flexible bag, with the adhesive being positioned to avoid a remainder portion of the periphery. For this embodiment, the disposable system can also include a protective cover that is positioned over the adhesive for selective removal therefrom to allow the adhesive to adhere to the remainder portion.

In another aspect of the present invention, an apparatus for warming a neonate nutritional liquid includes a warmer and the disposable system having a pouch and liner as described above. For the apparatus, the warmer includes a warming well having a closed first end and an open second end. The warmer includes at least one heating coil to heat the warming well which is typically made of a heat resistant material such as a metal or ceramic. A temperature sensor, such as a thermistor, can be positioned at the bottom of the warming well and the warmer can include a means for vibrating the warming well.

To use the apparatus, a container, such as a syringe, of neonate nutritional liquid is inserted into the liner and sealed. Next, the connector component of the liner is inserted into the pouch and engaged with the connecting component of the pouch. With this attachment, the assembly is placed within a warming well of the warmer. Next, the warming well is heated and vibrated. During this process, heat from the warming well passes through the conductive fluid in the pouch and through the thin flexible liner to the neonate nutritional liquid, to warm the neonate nutritional liquid in a uniform, controllable manner.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an exploded perspective view of a disposable system for use in warming a neonate nutritional liquid in accordance with the present invention;

FIG. 2 is a cross-section, exploded view of the system shown in FIG. 1 as seen along the line 2-2 in FIG. 1;

FIG. 3 is a cross-section view of ring-shaped connecting component for connecting a pouch to a liner as seen along the line 3-3 in FIG. 2;

FIG. 4 is a cross-section view of the system shown in FIG. 1 as seen along the line 2-2 in FIG. 1, shown with the liner inserted in and removably attached to the pouch;

FIG. 5 is a detail view as enclosed by circular arrow 5-5 in FIG. 4 illustrating a tang and groove attachment between a liner and pouch;

FIG. 6 is a cross-section view of another embodiment of a disposable system for use in warming a neonate nutritional liquid in accordance with the present invention, as in FIG. 4, having a ring-shaped pouch connecting component and a disk-shaped liner connecting component, shown with the liner inserted in and removably attached to the pouch;

FIG. 7 is a detail view as enclosed by circular arrow 7-7 in FIG. 6 illustrating a tang and groove attachment between a liner and pouch;

FIG. 8 is a cross-section view of another embodiment of a disposable system for use in warming a neonate nutritional liquid in accordance with the present invention, as in FIG. 4, having a two piece snap fastener system to removably attach the liner to the pouch;

FIG. 9 is a perspective view of an apparatus which includes a warmer for warming a neonate nutritional liquid within one of the disposable systems shown in FIGS. 1-8;

FIG. 10 is a perspective, partially exploded view of pertinent internal components of a warmer and disposable system for use in warming a neonate nutritional liquid, including a controller, vibrator and heater; and

FIG. 11 is a cross-section view of a disposable system for use in warming a neonate nutritional liquid position in a well of a warmer as seen along the line 11-11 in FIG. 10.

### DESCRIPTION OF THE PREFERRED EMBODIMENTS

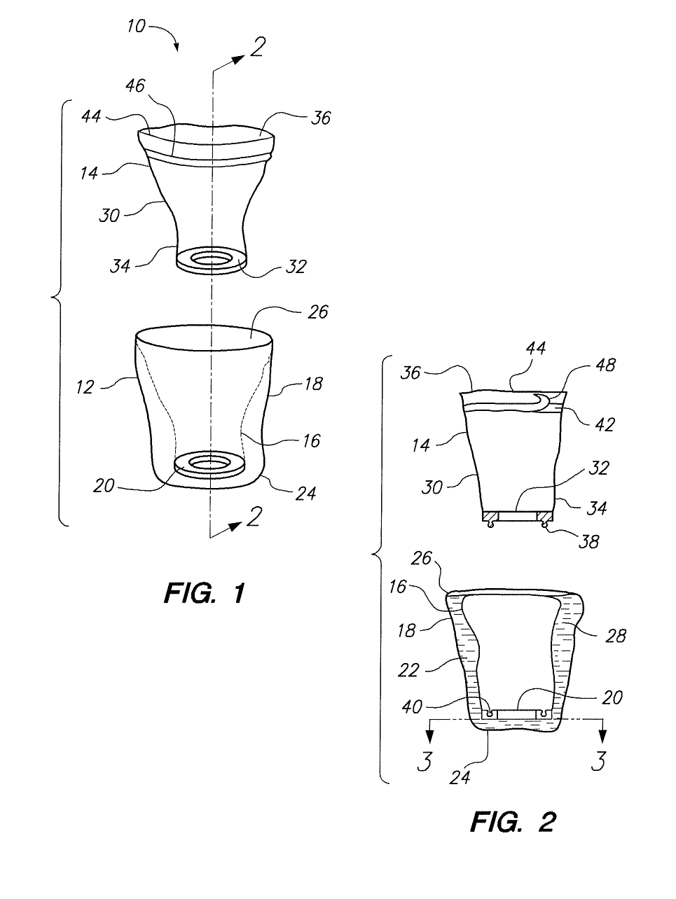

With initial reference to FIG. 1, a disposable system for use in warming a neonate nutritional liquid in accordance with the present invention is shown and generally designated 10. As shown, the system 10 includes a pouch 12 and a liner 14. As explained further below, a container of neonate nutritional liquid can be inserted into the liner 14 and the liner 14 can be removably attached to the pouch 12. The assembly is then placed in a well of a warmer to uniformly heat the neonate nutritional liquid.

Continuing with FIG. 1, the pouch 12 includes a flexible inner bag 16, a flexible outer bag 18 and a rigid connecting component 20. As best seen in FIG. 2, the inner bag 16 and outer bag 18 are coupled to each other to establish a permanently sealed compartment 22 between the bags 16, 18. For the embodiment shown in FIGS. 1 and 2, the inner bag 16 is attached to the connecting component 20. As shown, the pouch 12 extends from a closed first end 24 to a second, open pouch end 26. As best seen in FIG. 2, the compartment 22 that is established by the pouch 14 is at least partially filled with a thermally conductive fluid 28. For example, the thermally conductive fluid 28 may be a gel type substance or it may be a liquid such as water. As detailed further below, this cooperation of structure allows heat to flow from the outside of the pouch 14 to a neonate nutritional liquid that is disposed within the pouch 14.

FIGS. 1 and 2 also show that the disposable system 10 includes a liner 14 having a flexible bag 30 and a rigid connector component 32. As shown, end 34 of the bag 30 is attached to the connector component 32 and end 36 of the bag 30 is open. This allows the liner bag 30 to receive and hold a container of neonate nutritional liquid.

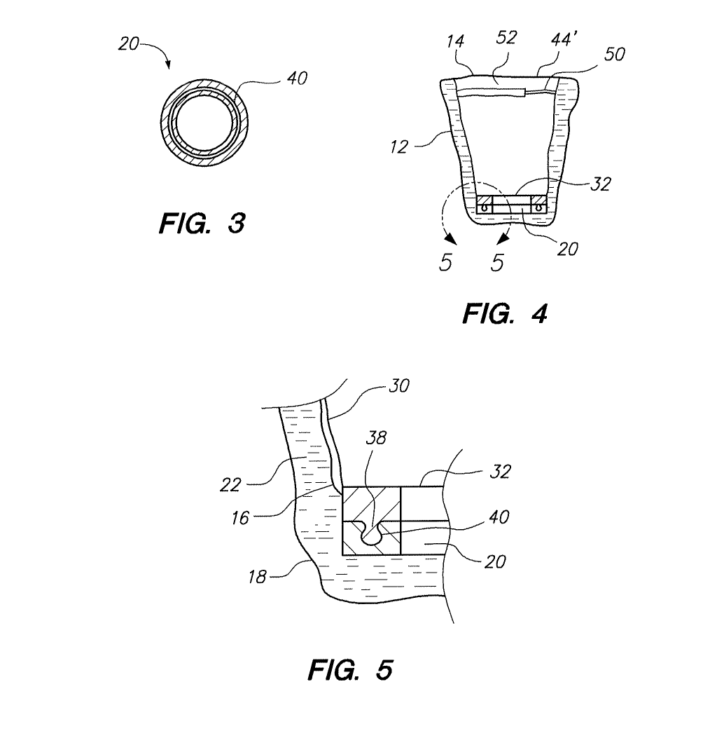

Cross referencing FIGS. 1-5, it can be seen that the rigid connecting component 20 of the pouch 12 and the connector component 32 of the liner 14 are both formed as rings. To establish an attachment between the pouch 12 and liner 14, the connector component 32 of the liner 14 is formed with a tang 38 that can extend around the ring-shaped connector component 32 on a bottom surface of the connector component 32. Also shown, the rigid connecting component 20 of the pouch 12 is formed with a groove 40 that can extend around the ring-shaped connecting component 20 on a bottom surface of the connecting component 20. To removably attach the liner 14 to the pouch 12, the groove 40 is sized to receive the tang 38 and snap the connecting component 20 and connector component 32 together (shown attached in FIGS. 4 and 5). With this arrangement, the liner 14 and container of neonate nutritional liquid are unable to move/migrate to an undesirable position in the pouch during heating and vibration of the system 10. As indicated above, this undesirable movement can cause the container of neonate nutritional liquid to move to a position where the neonate nutritional liquid is not uniformly heated.

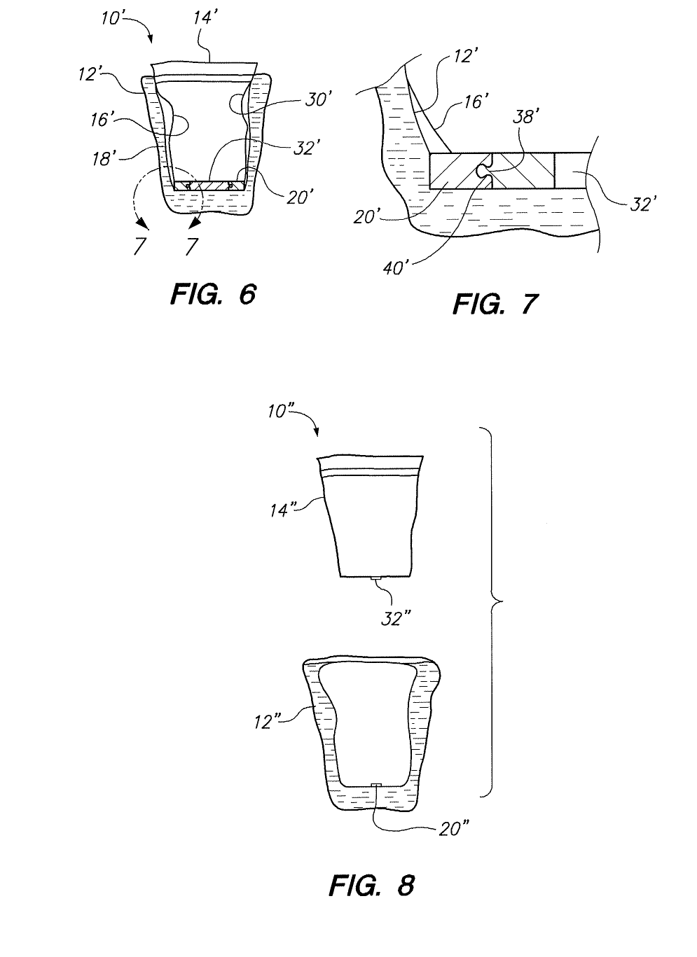

FIGS. 6 and 7 show another embodiment of disposable system (generally designated 10′) for use in warming a neonate nutritional liquid in accordance with the present invention. As shown, for this embodiment, the rigid connecting component 20′ of the pouch 12′ is formed as a ring surrounding a recess and the connector component 32′ of the liner 14′ is formed as a disk that is sized to fit in the recess of the ring-shaped connecting component 20′. To establish an attachment between the pouch 12′, having bags 16′, 18′ and liner 14′ having bag 30′, the connector component 32′ of the liner 14′ is formed with a tang 38′ that can extend around the ring-shaped connector component 32′ on a inner surface of the connector component 32′. Also shown, the rigid connecting component 20′ of the pouch 12′ is formed with a groove 40′ that can extend around the ring-shaped connecting component 20′ on a outer surface of the connecting component 20′. To removably attach the liner 14′ to the pouch 12′, the groove 40′ is sized to receive the tang 38′ and snap the connecting component 20′ and connector component 32′ together (shown attached in FIGS. 6 and 7). With this arrangement, the liner 14′ and container of neonate nutritional liquid are unable to move/migrate to an undesirable position in the pouch during heating and vibration of the system 10′.

It is to be appreciated that in alternate embodiments (not shown) the tang 38, 38′ can be formed on the connecting component 20, 20′ of the pouch 12, 12′ and the corresponding groove 40, 40′ can be formed on the connector component 32, 32′ of the liner 14, 14′.

FIG. 8 shows another embodiment of a disposable system (generally designated 10″) for use in warming a neonate nutritional liquid in accordance with the present invention. As shown, for this embodiment, the rigid connecting component 20″ of the pouch 12″ is formed as one part of a snap fastener similar to the snap fasteners used in clothing. For this embodiment, the connector component 32″ of the liner 14″ is formed as a corresponding, mating part of the snap fastener part used on the connecting component 20″. To removably attach the liner 14″ to the pouch 12″, the connecting component 20″ and connector component 32″ are snapped the together. With this arrangement, the liner 14″ and container of neonate nutritional liquid are unable to move/migrate to an undesirable position in the pouch during heating and vibration of the system 10″.

Returning now to FIGS. 1 and 2, it can be seen that the liner 14 can include a mechanical seal having an adhesive 42 that is positioned along at least 50% of a periphery 44 of the liner flexible bag 30, with the adhesive 42 being positioned to avoid a remainder portion 46 of the periphery 44 (i.e. a portion of the bag without any adhesive, shown as a dark band for clarity). For this embodiment, a protective cover 48 (shown partially peeled from the adhesive 42) can be positioned over the adhesive 42 for selective removal therefrom to allow the adhesive 42 to adhere to the remainder portion 46. Alternatively, as shown in FIG. 4, the, the mechanical seal is a ridge-into-groove connector sometimes referred to as a so-called ‘zip-lock’ or ‘plastic zipper’ type seal. As illustrated in FIG. 4, the ridge-into-groove connector can include a ridge 50 overlaying about half of the periphery 44′ and a groove 52 overlaying about half of the periphery 44′.

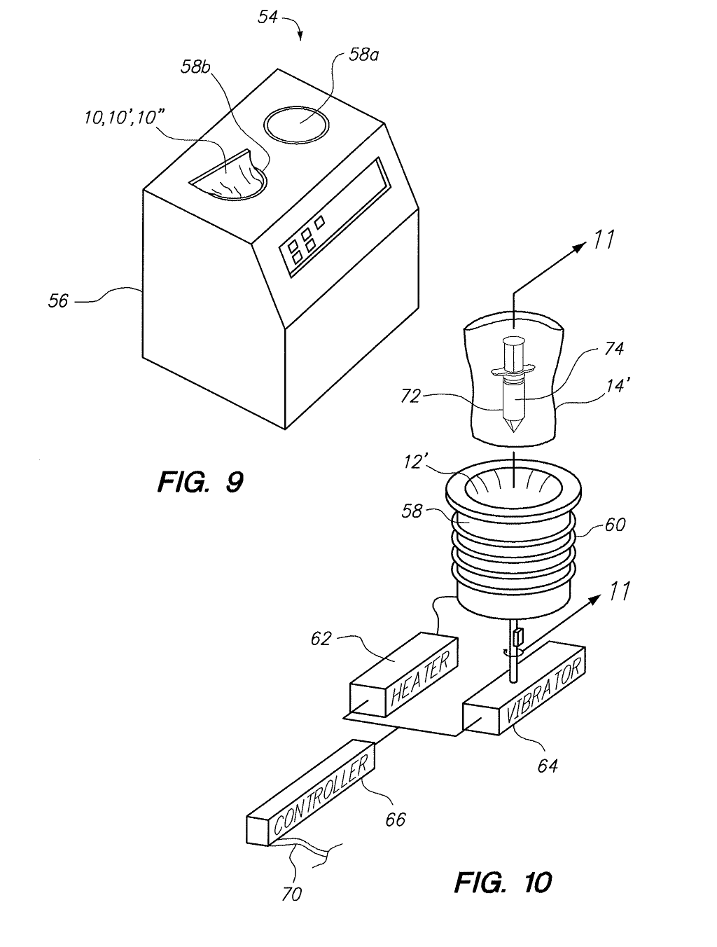

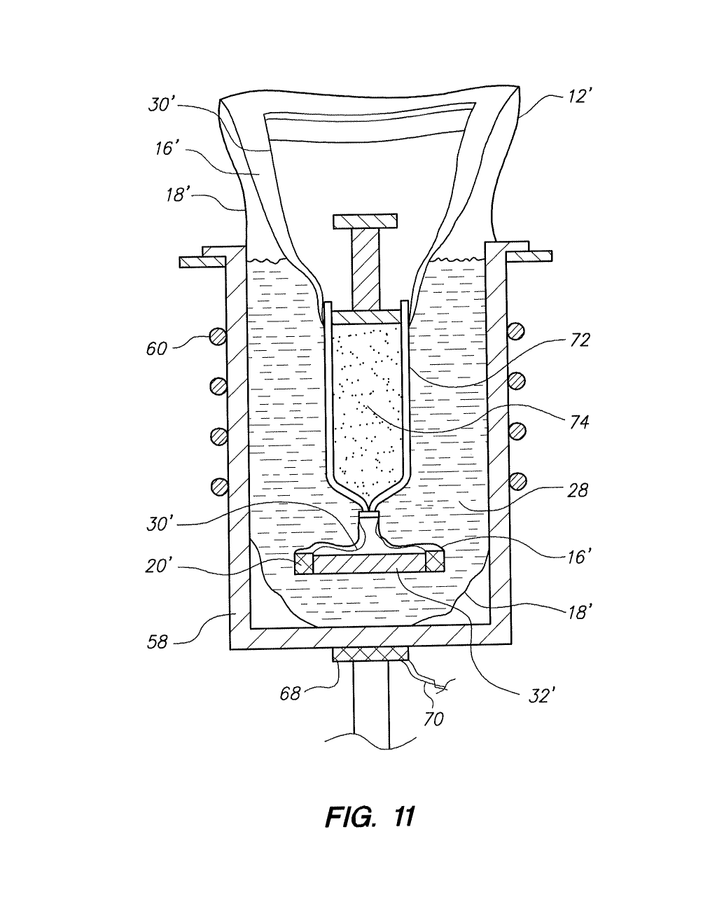

FIG. 9 shows an apparatus 54 which includes a warmer 56 for warming a neonate nutritional liquid within one of the disposable systems 10, 10′, 10″ shown in FIGS. 1-8. As shown in FIG. 9, the warmer 56 includes two warming wells 58a,b, which are typically made of a heat resistant material such as a metal or ceramic, and are sized to receive and hold a container of neonate nutritional liquid within one of the disposable systems 10, 10′, 10″. FIG. 10 illustrates pertinent internal components of the warmer 56 shown in FIG. 9. As shown in FIG. 10, these components can include a heating coil 60 attached to heater 62 to heat the warming well 58. A vibrator 64 can also be included to vibrate the well 58 and its contents. FIG. 10 also shows that a controller 66 can be included to control the heater 62 and vibrator 64 in accordance with user inputs and/or a pre-programmed protocol. As shown in FIG. 11, a temperature sensor 68, such as a thermistor, can be positioned at the bottom of the warming well 58 or at another suitable location and used to measure the temperature of the well 58 and the fluid 28 in the pouch 12′. The measured temperature can then be used by the controller 66 (shown in FIG. 10), via wire 70, in a feedback arrangement to control the warming process.

Continuing with reference to FIGS. 10 and 11, in which the system 10′ shown in FIG. 6 is used for illustrative purposes, it can be seen that to use the apparatus, a container 72, such as a syringe, of neonate nutritional liquid 74 is inserted into and sealed within the liner 14′. Next, the connector component 32′ of the liner 14′ is inserted into the pouch 12′ and engaged with the connector component 20′ of the pouch 12′ and the assembly is placed within a warming well 58 as shown in FIG. 11. Next, the warming well 58 is heated and vibrated. During this process, heat from the warming well 58 passes through the conductive fluid 28 in the pouch 12′ and through the liner 14′ to the neonate nutritional liquid 74, to warm the neonate nutritional liquid 74 in a uniform, controllable manner.

While the particular sanitary bag system for warming a neonate nutritional liquid, and corresponding methods of assembly and use, as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A disposable system for use in warming a container of neonate nutritional liquid, said system comprising:
a pouch having a first flexible bag attached to a rigid connecting component and a second flexible bag, the first and second bags coupled to each other to establish a permanently sealed compartment;
a conductive fluid disposed within the compartment; and
a liner having a flexible bag attached to a rigid connector component, the liner bag formed with an open end for receiving a container of neonate nutritional liquid and with the connector component of the liner configured for insertion into the pouch to engage the liner connector component with the pouch connecting component to removably attach the liner to the pouch.

2. A system as recited in claim 1 wherein the conductive fluid is a liquid.

3. A system as recited in claim 2 wherein the liquid is water.

4. A system as recited in claim 1 wherein the conductive fluid is a gel.

5. A system as recited in claim 1 wherein the flexible first bag is an inner bag and the flexible second bag is an outer bag.

6. A system as recited in claim 1 wherein the rigid connecting component comprises an annular ring.

7. A system as recited in claim 1 wherein one of the connecting component and the connector component is formed with a tang and the other is formed with a groove sized to receive the tang and snap the connecting component and connector component together.

8. A system as recited in claim 1 wherein the liner flexible bag includes a mechanical seal located adjacent the open end of the liner flexible bag to selectively enclose the container of neonate nutritional liquid inside the liner flexible bag during a warming procedure.

9. A system component as recited in claim 8 wherein the mechanical seal is a ridge-into-groove connector.

10. A system component as recited in claim 8 wherein the mechanical seal comprises:
an adhesive positioned along at least 50% of a periphery of the liner flexible bag, with the adhesive being positioned to avoid a remainder portion of the periphery; and
a protective cover positioned over the adhesive for selective removal therefrom to allow the adhesive to adhere to the remainder portion.

11. A system for warming a neonate nutritional liquid, said system comprising:
a warmer including a warming well having a closed first end and an open second end;
a pouch sized for insertion into the warming well and having a first flexible bag attached to a connecting component and a second flexible bag, the first and second bags are coupled to each other to establish a permanently sealed compartment;
a conductive fluid disposed within the compartment; and
a liner having a flexible bag attached to a rigid connector component, the liner flexible bag formed with an open end for receiving a container of neonate nutritional liquid and with the connector component of the liner configured for insertion into the pouch to engage the liner connector component with the pouch connecting component to removably attach the liner to the pouch.

12. A system as recited in claim 11 wherein the warming well is made of metal.

13. A system as recited in claim 11 wherein the warming well is made of a ceramic material.

14. A system as recited in claim 11 wherein the warmer includes at least one heating coil to heat the warming well.

15. A system as recited in claim 11 wherein the warmer includes a temperature sensor for measuring temperature at the bottom of the warming well.

16. A system as recited in claim 11 wherein the temperature sensor is a thermistor temperature sensor.

17. A system as recited in claim 11 wherein the warmer includes a means for vibrating the warming well.

18. A method for assembling a disposable system for use in warming a neonate nutritional liquid, said method comprising the steps of:
providing a pouch having a first flexible bag attached to a connecting component and a second flexible bag, the first and second bags coupled to each other to establish a permanently sealed compartment;
disposing a conductive fluid in the compartment;
providing a liner having a flexible bag attached to a rigid connector component, the liner bag formed with an open end for receiving a container of neonate nutritional liquid;
inserting the connector component of the liner into the pouch; and
engaging the connector component of the liner with the connecting component of the pouch to removably attach the liner to the pouch.

19. A method as recited in claim 18 wherein the rigid connecting component comprises an annular ring.

20. A method as recited in claim 18 wherein one of the connecting component and the connector component is formed with a tang and the other is formed with a groove sized to receive the tang and snap the connecting component and connector component together.
